(19) United States
(12) Patent Application Publication
(10) Pub. No.: US 2007/0256078 A1
(43) Pub. Date: Nov. 1, 2007

(54) Resource reservation system, method and program product used in distributed cluster environments

(76) Inventors: Nathan B. Falk, Wappingers Falls, NY (US); Iris L. Harvey, Wappingers Falls, NY (US); Paula W. Trimble, Rhinebeck, NY (US); Enci Zhong, Poughkeepsie, NY (US)

Correspondence Address: Lily Neff;IBM Corporation - MS P386, 2455 South Road, Poughkeepsie, NY, 12601, US

(21) Appl. No.: 11/414,029

(22) Filed: Apr. 28, 2006

(51) Int. Cl. G06F 9/46

(52) U.S. Cl. 718/104

(57) ABSTRACT

A system, method and program product is provided for reserving resources in a computing environment, and especially a distributed cluster environment. The method comprises the steps of analyzing specific requests relating to a received reservation and checking their sufficiency. Resource availability is then checking based on this information. Resources are then reserved and a new reservation created when above mentioned conditions are satisfied.

### BACKGROUND OF THE INVENTION

1. Field of the Invention

This invention relates to a method, system and program product for scheduling jobs in a computing environment and more particularly in a distributed cluster computing environment.

2. Description of Background

Computing environments that support distributed clusters provide many advantages in terms of speed and efficiency. A computer cluster is a group of loosely coupled computers that work together closely so that in many respects they can be viewed as though they are a single computer. Clusters are commonly, but not always, connected through fast local area networks. They are usually deployed to improve speed and/or reliability over that provided by a single computer, even large computers such as servers, while typically being much more cost-effective than single computers of comparable speed or reliability.

There are different type of clusters, each designed selectively for a specific task. For example, high availability clusters provide redundant nodes to address system needs in case of failure. Similarly, load balancing clusters operate in a way that allow all workload to pass through one or more load balancing front ends which then distribute the work accordingly. High performance clusters may be implemented to increase performance by splitting a computational task across many different nodes in the cluster. Other types of clusters, not mentioned above, are also available and selectively designed to address other needs.

In distributed computing, multiple independent computers communicate over a network to accomplish a common objective or task. The type of hardware, programming language(s), operating system(s) and other resources used in such environments may vary drastically. Concepts used in distributed computing is similar to those utilized by computer clusters and can be combined to provide many advantages to a plurality of resources that are disposed locally or dispersed geographically in a widely large area. The resources are often referred to as nodes and these terms will be used interchangeably hereinafter.

The popularity of using distributed cluster computing environments has recently increased. This increase in popularity has led to particular design challenges. In sophisticated and busy environments, poor workload management can lead to job processing spikes where the number of jobs to be processed exceeds the available resources. Increasing available resources, even when possible, does not always ameliorate the problem, as not all jobs can run on all resources and many jobs are left unprocessed and competing for the same resources at the same time. This can greatly impact performance and processing speed of the entire environment.

Prior attempts at optimizing the workload in a distributed cluster computing environment have so far been unsuccessful. Consequently, an improved workload balancing solution is desired that can overcome the above mentioned challenges.

### SUMMARY OF THE INVENTION

The shortcomings of the prior art are overcome and additional advantages are provided through a system, method and program product for reserving resources in a computing environment, and especially a distributed cluster environment. The method comprises the steps of analyzing specific requests relating to a received reservation and checking their sufficiency. Resource availability is checked based on this information. Resources are then reserved and a new reservation created when above mentioned conditions are satisfied. In one embodiment, once a reservation request is granted one or more resources is bound to the job to be completed until job completion or cancellation occurs. In a particular embodiment, one or more policies restricting resource use is also checked.

In another embodiment a method of workload management is provided. The method allows one or more resources of a computing environment to be reserved in advance of job processing. Jobs are then scheduled based on these advance reservations of resources. Jobs are processed only in accordance to these previously made reservations or if preemptive conditions exist.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic illustration of a computing environment used in conjunction with one or more embodiments of the present invention;

FIG. 2 is a flowchart illustration of one embodiment of the present invention; and

FIG. 3 is a flowchart illustration of another embodiment of the present invention.

### DESCRIPTION OF THE INVENTION

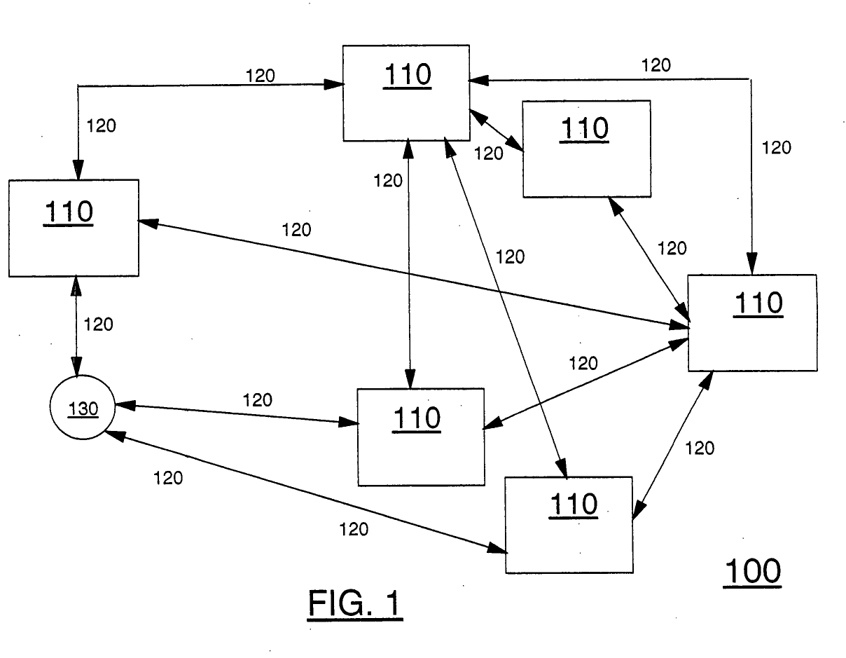

FIG. 1 is a schematic illustration of a computing environment 100, such a distributed clustered computing environment. The environment 100 includes a number of nodes or resources 110. The nodes can constitute a number of resources such as processors and disks, but are all referenced as 110 in FIG. 1 for ease of understanding. There are no geographical limitations or restrictions and nodes 110 of FIG. 1 can be either disposed locally or dispersed in a wide area.

The resources or nodes 110 are in processing communication with one another through a networking system 120 that may constitute one or more networking components, such as routers, local area networks (LANs) or other similar devices representatively shown in FIG. 1 and referenced as 130.

In one embodiment of the present invention, workload balancing is optimized through the use of a reservation system, hereinafter referred to as Advanced Reservation System (ARS). ARS provides for resource management in advance by granting resource reservation requests when possible. Only jobs designated to be eligible are allowed to run on reserved resources, or in certain cases when resource availability is not an issue or when special or preemptive conditions allow it other, jobs can also run.

ARS uses a resource or node (110) as the most basic unit for a reservation. One or more nodes are reserved to one or more jobs. In this way, jobs and resources can be matched up prior to job processing start time, so that a controlled schedule is achieved. This leads to efficient use of resources. In one embodiment a scheduler, or preferably a job scheduler, is used to control the reservation process. The scheduler can reserve nodes and match them with the jobs to be processed and provide other related services. The (job) scheduler, in FIG. 1, will also be in processing communication with one or more nodes (110) and can in fact be represented as one of the nodes (110) itself.

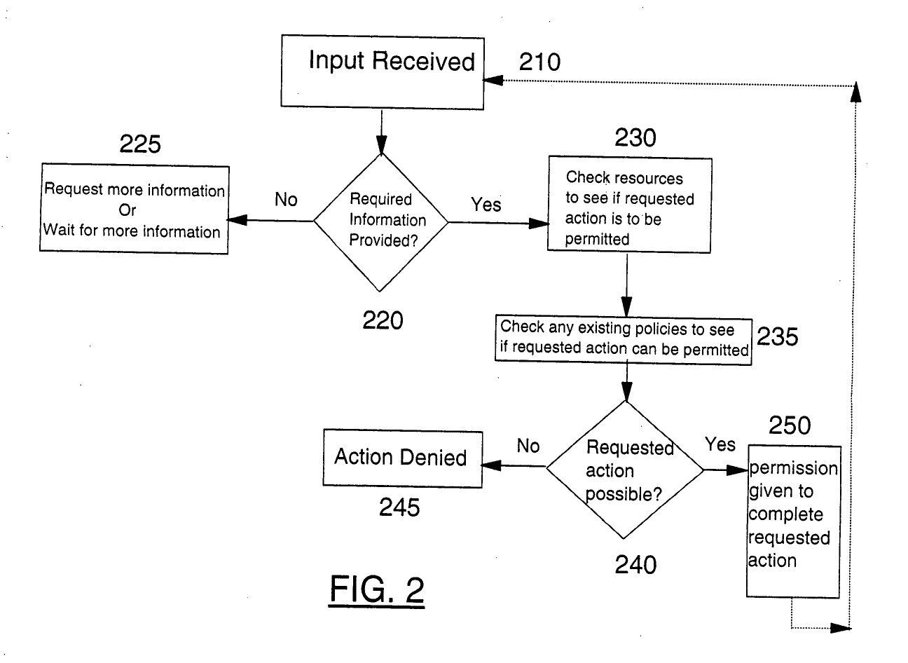

FIG. 2 is a flow chart illustration of ARS, as per one embodiment of the present invention. Input in form of reservation requests are first received as illustrated by block 210. The request can be received in a number of formats. For example, the request may be inputted by an end user from a command line or by using a graphical user interface (GUI) or an application programming interface (API). The request, however, does not need to necessarily be submitted by an end user and may be provided by another computer or even another environment.

ARS can process a number of different types of reservation requests including but not limited to requests for creation of new reservations and requests to query, modify and cancel existing reservations or even bind particular jobs to existing reservations. At the onset of this discussion, the focus will be on requests for creation of new reservations and other above mentioned requests will be discussed later.

Once a request for a creation of a new reservation is received, it is examined to see if it contains any special and unique requests. For example, a reservation request may specify the use of a particular node, or indicate a desired starting time. It should be noted that these unique requests, although provided at the onset of reservation creation, may be later modified, queried and/or cancelled accordingly when possible. In another example, a reservation may require exclusive use of certain resources or alternatively allow the reserved resources to be shared with other jobs.

In some embodiments, the requester may be forced to provide specifics about the reservation that by default sets up these special and unique request conditions. For example, the number or type of resources to be used may have to be specified even though the requestor does not need to choose a particular node per se. In another embodiment, the requestor may be forced to either prevent or allow automatic reservation or node cancellations in case of system failure or other similar conditions, to avoid resource waste. Alternatively, nodes can also be reserved for maintenance purposes so that jobs expected to run before the reservation start time will not be dispatched to run, thus creating other unique reservation request conditions.

Referring back to FIG. 2, the unique or specific information provided by the reservation request, has to be first examined for accuracy and completeness. The process is illustrated by the use of decision block referenced as 220.

When specific requests are made, ARS ensures that all information pertaining to that specific request is provided to ensure correct reservation of resources. If the provision of certain information is mandatory, ARS will check that all mandatory information is provided before further processing the request. Insufficient or incomplete information will prevent further processing of the request.

The required information relating to a specific reservation request is not the same in every case. For example, when creating a new reservation, the reservation start time, duration and specifics such as number and type of nodes to be reserved can be provided or may be mandatory. The following example is reflective of this fact.

In a particular example, the requester is given the three following options when creating a new reservation request. Selecting one or more of these options is mandatory at reservation request time:

1. provide the number of nodes to reserve;

2. precisely list which node(s) to reserve; and

3. allow a set of nodes to be selected which satisfy the requirements of a given job.

In this example, in creating the reservation, the first and third options provide maximum flexibility and may require less information to be associated with them. In both cases, any existing job scheduling algorithm in the environment can be used when the reservation creation request is made to determine resource availability. This is a time-saving feature especially in circumstances where an actual person or user is creating the reservation. In such an instance, in creating the reservation, the user does not need to manually evaluate and select specific nodes in order to make the reservation. The third option is additionally advantageous in that it ensures that the nodes once selected will have sufficient resources to run a particular job when the reservation starts.

In this way, the particulars of the reservation request can prompt ARS to impose additional restrictions and require more specific data submission before further processing of the request. For example, the reservation system may be designed to provide all or a subset of the following attributes in some such cases:

ID: Name of the reservation (only for existing reservations);

Owner: The userid which owns the reservation;

Group: The group which owns the reservation;

Start Time: The time that the reservation is scheduled to start;

Duration: How long the reservation lasts;

Nodes: A list of nodes reserved by the reservation;

Options: exclusive use or allow sharing; terminate at end time or automatically terminate if no jobs can run;

State: The state of a reservation;

Jobs: A list of jobs bound to the reservation (to be run on the reserved nodes);

Users: A list of individual users who are allowed to run jobs in the reservation;

Groups: A list of groups whose users are allowed to run jobs in the reservation;

Creation Time: The time when the reservation was created;

Modified By: The userid who last created or modified the reservation; and

Modification Time: The time when the reservation was last created or modified.

Referring back to FIG. 2, once the specific information is received about the reservation, other information about the request is examined to see if its request can be granted. This is reflected in the different paths emerging from decision block 220. If all or any portion of the required information relating to the specifics of the reservation is not provided, further processing of the request is not allowed. In different embodiments, either more information will be requested or other conditions such as an error message or reservation termination will ensue after a wait period.

Resource availability is then examined based on the information provided as part of the request as reflected by block 230.

Resource availability depends greatly on existing reservations, running jobs and whether a node is permitted to be reserved. In one embodiment, when a reservation request is made, a node with a running job expected to run during the requested reservation time period is not available for the reservation request. In this instance, the reservations cannot overlap and no two reservations are allowed to share a node at the same time. Therefore, start times and durations have to be examined carefully before the reservation request can be granted. In addition, when examining resource availability, other auxiliary resources that may be needed to complete the job is also taken into consideration. This will guarantee that the requested reservation will be provided with sufficient resources to run the requested job to its completion.

In addition to actual resource availability, in some embodiments, additional restrictions may be imposed on resource use that, if not met, will make a resource unavailable for reservation purposes. These restrictions are known as policies. Policies are configured to tune the behavior of the reservation system and provide tighter control of resource use. A separate discussion about policies will be provided later in more detail. When policies are in place, reservation requests have to be examined to ensure that reservation requests do not violate the policies that are set in place. This latter is reflected in block 235 in FIG. 2.

The reservation will then be either granted or denied. This is shown in FIG. 2 by decision block 240 and subsequent steps of denying the request as shown by block 245, or alternatively granting it as shown by block 250. If reservation request is granted, a new reservation is then created. In one embodiment, the creation of a new reservation and subsequent processing of a successful reservation request is accompanied by issuance of a reservation identification (ID). This ID is provided to the requestor, which in most embodiments is now the owner of the reservation. This ID is unique to every reservation and will then be associated with it and its creation time (the ID identifies the reservation together with the reservation creation time). In most embodiments, the reservation ID will be required for all future operations or requested actions (query, modifications etc.) that pertain to the reservation. The ID is not only useful in providing access and information about the present state of reservation (while for example a job scheduler is continuously running), but it can also be used to establish historical records used for record keeping (the combination of the reservation ID and the reservation creation time make a reservation unique for historical purposes).

As indicated, in most embodiments once the reservation is granted, the submitter of the reservation request becomes the owner of the reservation. The submitter or the requester can be an end user or a machine or computer or even other environments. The owner of a reservation can use, cancel or modify the reservation or authorize others to do the same. The owner of a reservation may also belong to a group and additional ownership rights or restrictions may be imposed based on that group membership. A group owner can also be specified. Additional restrictions and policies may be enacted and imposed on individual users at user level or on groups at group level.

Once created, a reservation can then be modified any time before the reservation ends, using the same or similar processes as was used in conjunction with FIG. 2. This concept is shown by the dotted lines extended between reference block 250 and the start of the process as shown by reference block 210.

In one embodiment, when a modification request is made, most information can be altered but the modification of the reservation ID itself and its associated creation time are not allowed to be modified. Other attributes can be modified separately or at the same time subject to certain restrictions. For example, the reservation start time and duration can be increased or decreased. The reserved nodes can be replaced, additional nodes can be reserved and existing nodes deleted. These and other features can be checked as previously discussed in conjunction with decision block 220. If it is not possible to grant the modification (block 245), the reservation will stay the same as before the modification request.

Reservation attributes can be queried after a reservation is created and before the reservation ends. In one embodiment, it is even possible to establish a system such that by default, a query will display all reservations currently in the job scheduler. In a preferred embodiment, queries will be restricted to certain owners or groups or time frames.

Similarly, a reservation can be cancelled before or after the reservation starts. Just like when a reservation ends, all jobs bound to the reservation will be freed. However, these jobs will not necessarily change their status when being freed from a reservation.

Once created a reservation matches resources and jobs together. In addition, it is also possible to bind additional jobs to the reservation once created, as shown in the dotted line in FIG. 2.

The order of binding is not necessarily the order of running for bound jobs. In most cases, binding jobs to a reservation is necessary to run a workload. The bound jobs will be scheduled to run on the reserved nodes once the reservation starts. Many jobs are allowed to be bound to one reservation. The binding can occur at different times before or after a reservation starts. Both batch and interactive jobs can be bound to a reservation. The order of binding is not the order of running for bound jobs. A bound job can be freed from a reservation at any time.

A set of users who can run jobs in a reservation can be called users of the reservation. The users of a reservation can be specified in two ways. The attribute “Users” specify a list of individual users and the attribute “Groups” specify a list of groups whose users can use the reservation. Both can be used separately or at the same time depending on the embodiment desired. These users will then be allowed to run jobs in the reservation only.

It should also be noted that a variety of jobs, including interactive jobs as well as batch jobs, may be submitted to run on the reserved nodes before and during the reservation time frame. The jobs submitted to run in a reservation are said to be bound to the reservation. Any running jobs on the reserved nodes of a reservation which are not bound to that reservation will be preempted before the starting time of the reservation. When checking resource availability, running jobs on the reserved nodes are taken into consideration. In most cases, a reservation is not allowed to interfere with a running job and vice versa.

Once reservation is granted, reservation start time becomes an important attribute of a reservation, especially if specifically requested. This is the time the reservation can start to be used. To honor the start time of a reservation, no new jobs will be dispatched by the scheduler unless they are expected to complete before the start time of the reservation. Any jobs which are still running on the reserved nodes will be preempted before a reservation is about to start. Duration specifies how long the nodes can be reserved. While a reservation lasts, bound jobs will have the privilege to use the resources on the reserved nodes. Once the reservation ends, the formerly bound jobs will lose their privilege on the formerly reserved nodes.

In addition to start time and duration, if reservation has one or a set of nodes associated with it, these nodes belong to that reservation for the time duration of the reservation. The set of nodes are selected at the creation time of the reservation as discussed but in some embodiments, at least one particular node or a type of node must be specified. In one embodiment, all resources available on the reserved nodes, can be set by default to be used to run bound jobs so that a reservation will last for the entire duration.

If a reservation was created such that nodes can be shared (“SHARED” option), resource exclusivity conditions are removed. In such an embodiment, when the time comes to actually schedule jobs, all bound job steps will be scheduled to run first. Some bound job steps may have to wait until other bound jobs finish running to have enough resources to run. When all currently bound jobs that can run on the reserved nodes have been scheduled to run, a reservation with “SHARED” option will start to allow jobs not bound to the reservation to run on the reserved nodes to share the resources still available in the reservation. This will avoid wasting reserved resources which is advantageous when a large job is to be started at a specified time but the resource does not need to be exclusively used.

Other options may also have been provided which affect the way the jobs are run. For example, an option can be provided to efficiently use the resources and eliminate idle time. For ease of reference, this option will be called herein as “REMOVE_ON_IDLE” option but other similar names can be selected. The option is designed with the purpose of minimizing or eliminating resource waste.

In this embodiment, if a (job) scheduler is used, the (job) scheduler will automatically cancel a reservation when all currently bound jobs that can run finish running. This option can be chosen when the reservation duration may be longer than what needed to run the workload. It is also useful in case the promised resources are not all available, due to a failing node, for example. In such a case, the reservation may not have enough resources to run any of the bound jobs or only a portion of the bound jobs can run. Thus it is a good idea to cancel the reservation automatically at the right point of time to let other jobs use the resources instead of letting the reserved nodes stay idle, especially during unattended hours.

It should be noted that in an embodiment, where SHARED and REMOVE_ON_IDLE is utilized, these options do not conflict. Therefore, a reservation can be created with both options.

When scheduling jobs, no matter whether these jobs are bound to a reservation or not, certain availability information has to be considered with respect to assigning jobs to resources and nodes. First if any node is already being considered or used for an active reservation, that node is no longer considered for scheduling jobs unless it is placed in an ACTIVE_SHARED state. In addition, a node is assigned to a job only if the job is expected to end before the earliest start time of any reservation reserving the node in the future. Finally, when available resources in the future are being calculated, all reservations, active and waiting, are taken into account.

The concept of node availability both in the present and in the future is an important one. In many cases, there may be a presumed assumption that if a node is available to run a job now, the node will be available at any time in the future. In other words, that if a node is available to run a job at some time Tavailable, then that node will be available at time Tfuture=Tavailable+n for any n>=0.

The present invention recognizes that this may not always be the case and make design adjustments to achieve the best results. Although a node may be available to run a job at Tavailable time, starting the job at Tfuture could cause the job to overlap with an existing reservation on that node. Reservations can introduce “spikes” in what would otherwise be monotonically increasing resource availability. To be able to make scheduling decisions under the assumption that available resources will not decrease, the future time is divided into sub-intervals such that the pool of available resources does increase monotonically over each sub-interval. In this way, the existing scheduling algorithms can be used in each sub-interval.

Within each reservation, jobs which are bound to the reservation will be scheduled, for the most part, in the same manner as jobs that are not bound to a reservation. The difference, however, is that only reserved nodes are considered to run the bound jobs. In this way, only jobs bound to a reservation are considered to be scheduled in the reservation. The scheduler can be configured such that the bound jobs will only be scheduled if they are expected to complete before the end time of the reservation, or such that they may start before the reservation ends even if they will continue to run beyond that time.

It should be noted that preemption is disabled within a reservation in one embodiment. Preemption is a mechanism that can take resources away from some jobs to enable other jobs to run and be completed. A running job bound to a reservation can not be preempted by another job, whether the job is bound to the same reservation or not. A job bound to a reservation will not preempt any other job, whether it is bound to a reservation or not.

In one embodiment the (job) scheduler will examine the list of active reservations scheduling jobs before scheduling the jobs that are not bound to any reservation. The same scheduling algorithm is applied to the queue of waiting jobs in each reservation, including those that are not bound to any reservation.

The start and possibly end time of the reservations have to also be examined and honored. Before scheduling jobs, the start time of the reservation is compared against the node availability. If the earliest start time of that reservation using that particular node interferes with the expected end time of another job, the job will not be scheduled. Obviously, this policy is different for reservations and nodes with SHARED option.

In a case where the reservation has the SHARED option designation, once all jobs bound to the reservation which can run have been dispatched to run, the reservation's resources can be shared with jobs outside the reservation. It is important to recognize that sharing occurs once all jobs bound to the reservation which can run have been dispatched to run, as opposed to a situation where sharing or resources occur when all jobs bound to the reservation have been dispatched to run. The distinction here is that in the latter case there may be jobs bound to the reservation which will never be able to run on the reserved nodes. For example, if a job requires 8 nodes and only 6 reserved nodes are in the reservation, that job will never be able to run in the reservation given the above mentioned scheme.

In a case where the reservation has the REMOVE_ON_IDLE option, then once all jobs bound to the reservation which can run have finished running, the reservation will be removed so that the reservation will not stay idle wasting resources.

Referring back to FIG. 2, block 235, it was discussed that (job) scheduler or other entities have to check policies before granting reservation permission. Such policies may or may not be in effect in alternate embodiments of the present invention. When in effect, however, the variety of such policies are so diverse that it may be helpful to discuss them in some details below.

The policies when established are geared to provide better control over the reservation process. The variety of such established policies are so great that an exhaustive list will not be provided here, but a representative list will be discussed in detail to ease understanding. These and many other policies can be combined to form policy sets and subsets and selectively implemented as desired in different embodiments.

In addition, in one embodiment, a set of tuning parameters can be also provided and passed to better implement and define these policies in a distributed cluster. The examples provided below provide such parameters, with randomly selected names to ease understanding. Again other parameters with other names can be used in alternate embodiments of the present invention.

A first policy that can be enacted may deal with the maximum number of reservations a user or group can have at the same time can be defined. A parameter can be then passed and introduced with the name max_reservations, in this example, or other suitable names in alternate embodiments.

In addition, each user or group can also be provided its own quota or percentage of this maximum number. The quota can be established and set up before job scheduling and before the particular user or group can make a reservation. This can be accomplished in a number of ways. In one example, administrators will be setting up this quota. The administrators have the flexibility to setup quotas on the user, group or user and group basis. Once the quota limit is reached, an existing reservation has to end before a new one can be made (i.e. by default, no one can make any reservations then).

An example of a quota driven embodiment is provided in the example below. Table 1 below, summarizes the interaction between user quota and group quota in such an example.

TABLE 1
interaction between user quota and group quota:

| | | Number of Reservations this |
|---|---|---|
| User Quota | Group Quota | user can create in this group |
| not defined | not defined | 0 |
| 2 | not defined | 2 |
| not defined | 1 | 1 |
| 3 | 1 | 1 (The user may be able to |
| | | create more reservations in |
| | | other groups) |
| 1 | 2 | 1 |
| 0 | 2 | 0 |
| 1 | 0 | 0 |

Similarly MAX_RESERVATIONS or other similarly named policies and parameters can be established that specify the maximum number of reservations a cluster can have. A reasonable limit should be set and chosen here to avoid too many reservations affecting the (job) scheduler performance.

Other reservation policies can also be established. For example, a policy can be established to limit the maximum reservation duration a user or group can have, defined by max_reservation_duration (the default would be to place no limits on the length of the duration).

Other similar policies can also be established. For example reservation_permitted parameter (or other similarly named parameters with similar functions) can be introduced to specify whether a node in the cluster can be reserved by a reservation. The default option would be that all nodes in the cluster can be reserved. Also RESERVATION_MIN_ADVANCE_TIME (or other similarly named parameters) can be used to specify the latest time (minimum time in advance) that a reservation can be made before its start time. (Default option allows a reservation to be made at any time prior to start time). The purpose behind this policy is to allow sufficient time for efficiently scheduling jobs. In certain instances, it may be desirable not to allow new reservations to be active right away to reduce impact to execution of the current workload.

Similarly RESERVATION_SETUP_TIME, or similar policies and parameters can be introduced to allot only a certain time prior to each reservation for setup procedures. This setup time can include the time spent on checking and reporting of node conditions and availability as well as time spent on preempting jobs that are still running on the reserved nodes. In a preferred embodiment, the setup time can be set to sixty seconds. It is possible to even set a zero setup time (when not specified this will be the default setup time) in situation where it is not critical to get the setup work done before the reservation start time.

RESERVATION_CAN_BE_EXCEEDED, policy and parameter can be established to specify whether jobs expected to end beyond the reservation end time can be dispatched to run in case of node availability. This can be selectively set by the user, for example. Selection or non-selection of this option each provides its own advantages. Selection of it makes better use of the reserved resources before a reservation ends, while not selecting or allowing it will make a reservation end cleanly, with no other jobs running.

Reservation priority can be established with the parameter RESERVATION_PRIORITY, or other such named parameters. The purpose here is to allocate whether administrators or others can make a reservation by cutting down or through the expected running time of currently running jobs. (A default option can be provided, that prevents such action unless specifically selected.) This option will be selected occasionally, when there may be a need to make a reservation regardless of when jobs end.

Besides, the policies mentioned in detail above some other policies can be established to monitor the following activities:

policies to allow administrators to modify, cancel, bind or free any jobs to or from any reservations;

policies to allow only one group, such as administrators, to only have permission to modify the owner of a reservation;

policies relating to the reservation ID, and particularly that the ID and the creation time of a reservation cannot be modified by anyone;

policies allowing the owner of a reservation to modify, cancel, bind or free its own jobs to or from the reservation;

policies allowing a user of a reservation only to be able to bind or free its own jobs to or from the reservation;

policies preventing the modification of the start time of an active reservation;

once a reservation is active, enacting policies where only a certain select group, such as administrators can add or delete reserved nodes (this policy may be necessary in case a bad node need to be replaced);

policies preventing normal users to change reserved nodes if the reservation is about to start within a time period (such as specified by RESERVATION_MIN_ADVANCE_TIME etc).

As mentioned earlier, other similar policies can be established and the above mentioned list is not to be considered an exhaustive list of available policies under the workings of the present invention.

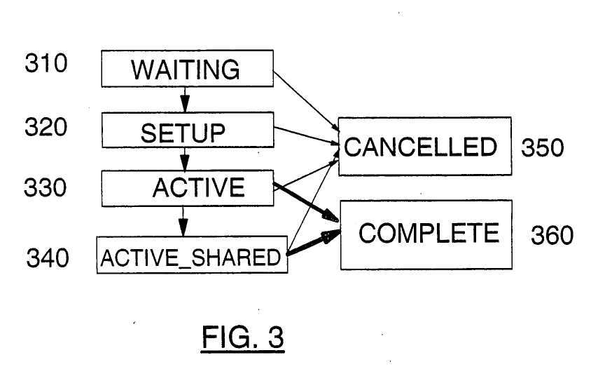

FIG. 3 is an illustration of a reservation lifecycle. The illustration of FIG. 3 is specially designed to use in situations where the state of a reservation changes during its life cycle and is dynamic. Beside cancellation and completion, respectively depicted by blocks 350 and 360, prior to completion or cancellation of each job, the reservation can either be in waiting (reference block 310), active (reference block 330), in its setup state (reference block 320) or allowed to share (reference block 340). The relationships between these states are illustrated by arrows in FIG. 3 and will be discussed presently.

The lifecycle process starts as shown in FIG. 3, for every reservation, conceivably at a wait state as indicated by reference block 310. In other words, at the onset of every received reservation request in a cluster, the request will be checked against availability, such as by the job scheduler running in the cluster. The (job) scheduler will check the request against the reservation policies of the cluster if any as was discussed above. If the request can be granted, as was discussed in FIG. 2, a reservation is made with all necessary information stored in the job scheduler and the “WAITING” state or status is then granted.

As illustrated, after the waiting status is achieved, once it is time to initiate the setup steps, reservation state and status will then be changed to “SETUP” as indicated in block 320. A variety of different setup procedures can be alternatively selected. In one embodiment, for example, setup time may mean that all running jobs on the reserved nodes of the reservation will be preempted and the availability of every reserved node is checked. It may also mean that in case there is a problem (such as when a node is down for service reasons), the owner of the reservation and administrators will be notified through email or other means.

Once setup is complete and when the reservation start time is reached, the reservation state becomes “ACTIVE” as illustrated by block 330. In one embodiment, this may mean that the job scheduler will start to dispatch jobs bound to the reservation to run. Jobs can be bound to or freed from a reservation before or after a reservation becomes active. Normally, the reservation will stay alive until its duration has passed, whether the reserved resources are fully used or not.

The “SHARED” option may or may not be used in different embodiment. However, if the SHARED option is used and on, as indicated by block 340, the reservation state will change to ACTIVE_SHARED after all bound jobs for which the reserved resources are sufficient have started to run, as was discussed earlier. In one embodiment, this means that the job scheduler will then start to use available resources in the reservation to run jobs not bound to the reservation.

The reservation is then either allowed to complete as shown by block 360 or cancelled prior to completion as indicated by block 350. If a reservation ends normally, the reservation state changes to COMPLETE as stated by block 360. Reservations can be also cancelled in a number of ways. In one embodiment, as discussed earlier, a reservation can be cancelled by end users, administrators or even the (job) scheduler. If a reservation is cancelled by these entities, the reservation state becomes CANCELLED as indicated by block 350.

In either case when a reservation ends for whatever reason, completion or cancellation, the jobs bound to the reservation will be freed from the reservation. The running jobs will continue to run as a job not bound to a reservation. A historical record will be stored for the reservation that just ended. In one embodiment, it is even possible to create one or more accounts for a user or a group of user (or a user within a group) based on the historical data gathered. The account can be used for a number of purposes such as charging reservation fees when desired.

It should also be noted that once a SHARED option is used in conjunction with a REMOVE_ON_IDLE option, once all bound jobs for which the reserved resources are sufficient have finished running, the reservation will be also be cancelled by the job scheduler as indicated by the arrows in the illustration of FIG. 3.

To summarize the illustration of FIG. 3, a reservation is in “WAITING” state (310) before the reservation start time; it changes into the “SETUP” state (320) right before the reservation is about to start; and it will be in the “ACTIVE” state (330) after the reservation start time. Similarly, a reservation is in “CANCELLED” state (350) when a cancellation request is received; or a reservation is in “COMPLETE” state (360) when the reservation ends. It should be noted that both “CANCELLED” and “COMPLETE” states, 350 and 360 respectively, are transient states and a reservation will not be in those states for long. When an active reservation starts to share its resources, the reservation state will change from ACTIVE to ACTIVE_SHARED (340).

As the previous discussions highlight, ARS as provided by one or more embodiments of the present invention can be used for any special purpose like to run a particular job or workload. This provides particular advantages in a clustered environment as it minimizes waste and increases usability.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of managing a workload, comprising:
reserving one or more computing environment resources among a plurality of available resources in advance of job processing;
scheduling jobs in advance in accordance with said reserved resources;
processing only jobs scheduled in advance and other jobs which preempt said scheduled jobs under one or more predetermined conditions.

2. A method of reserving resources in a computing environment, comprising:
receiving a reservation request for reserving resources within computing environment;
analyzing any specific requests in accordance with said reservation request;
checking said specific request(s) for sufficiency of required information;
checking availability of said resources based on said reservation request and said required information; and
reserving said resources when said required information is sufficiently provided and said resource availability exists.

3. The method of claim 2, wherein one or more jobs are bound to said reserved resources for processing completion.

4. The method of claim 3, wherein said reservation includes information about start and duration of said reservation to be made.

5. The method of claim 3, wherein said reservation request also includes resource requirements.

6. The method of claim 3, wherein said resources are nodes of a distributed clustered environment and said nodes are in processing communication with one another.

7. The method of claim 3, wherein said reservation request is granted only after said reservation information satisfies one or more policies.

8. The method of claim 1, wherein nodes can be reserved for maintenance purposes.

9. The method of claim 7, wherein said resources can be either reserved exclusively or on a shared basis.

10. The method of claim 9, wherein said resource ownership is switched whenever said resource is idle based on pre-specified conditions or as allowed by one or more preemptive conditions.

11. The method of claim 1, wherein said reservation request when granted is then provided a unique identification (ID) to be used subsequently every time said reservation is to be used in subsequent actions.

12. The method of claim 1, wherein once said new reservation is created, said reservation can be further modified, queried or cancelled.

13. The method of claim 12, wherein said modification is allowed only when resource availability exists and required information pertaining to modification specifics are provided.

14. The method of claim 1, wherein once said new reservation is created, specific jobs can be requested to be bound to said reservation or one or more resources.

15. The method of claim 1, wherein said reservation can be cancelled by original requester or selectively by another entity having cancellation rights.

16. The method of claim 1, further comprising the step:
upon granting reservation request, placing said reservation request in a waiting queue based on resource(s) to be used for subsequent completion;
performing one or more setup procedures prior to completion of said reservation request after placing said reservation request in said queue;
determining if reserved resources are to be exclusively used or shared based on reservation information;
binding said resources to said reservation request either exclusively or on a shared basis until resource(s) has completed required task for which said reservation was made.

17. The method of claim 1, wherein said previously reserved resource(s) is released upon reservation completion or cancellation.

18. The method of claim 1, wherein preemption priority can be provided to grant permission to reservation requesting unavailable resources by reallocating resources and taking these resources away from some jobs to enable other jobs to run and be completed.

19. The method of claim 1, wherein said reservation requests are handled by a job scheduler.

20. The method of claim 19, wherein said job scheduler examine a list of active reservations scheduling jobs before scheduling jobs that are not bound to any reservation.

21. The method of claim 1, wherein said submitter of said reservation request becomes owner of said reservation when granted.

22. The method of claim 1, historical data is generated each time reservation is completed or cancelled.

23. The method of claim 22, wherein said historical data is used to establish an account for specific users or groups users within a group.

24. The method of claim 1, wherein said reservations and job processing is examined to ensure that said jobs are not being processed on said resources such as to create overlapping of said reservations and that said jobs are not running beyond their allowable reservation duration.

25. A reservation system for use in reserving resources within a computing environment, comprising:
a plurality of resources in processing communication with one another;
a scheduler also in processing communication with said resources and operable for reserving said resources based on availability in advance of to be processed jobs;
said scheduler also operable to assigning jobs to said reserved resources once said reservation has been made.

26. The system of claim 25, wherein said scheduler can reserve one or more resources and bind them exclusively to specific jobs.

27. The system of claim 25, wherein resource availability is determined by checking any specific requests made in conjunction with said reservation.

28. The system of claim 25, wherein resource reservation is allowed only if reservation request does not violate one or more policies restricting resource use.

29. The system of claim 28, wherein said policy can limit maximum number of resources to be used, maximum duration of requested reservation; establish reservation policy and allow certain users to modify, cancel, bind, modify ownership information or free any jobs to or from any reservations.

30. A computer usable medium including computer usable program code for reserving resources in a computing environment; said computer program product comprising:
computer usable program code for requesting reservations of one or more resources prior to running of one or more jobs;
computer usable program code for providing specific information pertaining to reservation request;
computer usable program code for examining resource availability based on specified information for said reservation request;
computer usable program code for binding jobs to resources upon resource availability of requested resources for said reservation request; and
computer usable program code for releasing resources upon job cancellation or completion pertaining to said requested reservation.
